(19) United States
(12) Patent Application Publication
(10) Pub. No.: US 2016/0239916 A1
(43) Pub. Date: Aug. 18, 2016

(54) DATA STRUCTURE OPTIMIZATION SYSTEM

(71) Applicant: ATLAS Portfolio, LLC, Woodbury, MN (US)

(72) Inventors: Alexander E. Korn, New York, NY (US); Jeff Landt, New Richmond, WI (US)

(21) Appl. No.: 15/139,178

(22) Filed: Apr. 26, 2016

Related U.S. Application Data
(63) Continuation-in-part of application No. 14/213,344, filed on Mar. 14, 2014.
(60) Provisional application No. 61/794,858, filed on Mar. 15, 2013.

(51) Int. Cl. G06Q 40/04

(52) U.S. Cl. CPC G06Q 40/04

(57) ABSTRACT

A data structure optimization system for implementing desired asset allocation using a network flow algorithm. More specifically, a computer-implemented system that enables an individual to take preferences and constraints for a financial portfolio and accomplish allocation-driven, tax minimizing, and rule abiding trading efficiently and with precision. The system collects information about an individual's assets and the individual's preferred asset allocation and determines trades that, when made, will change the current asset allocation to more closely match the desired asset allocation. This information can then be exported to an external trading platform in the market.

### CROSS-REFERENCE TO RELATED APPLICATION

This application is a continuation-in-part of U.S. Nonprovisional application Ser. No. 14/213,344 filed Mar. 14, 2014, titled ASSET DATA MANAGEMENT SYSTEM AND METHOD, which claims the benefit of U.S. Provisional Application No. 61/794,858 filed Mar. 15, 2013, titled ASSET ALLOCATION MANAGEMENT SYSTEM AND METHOD.

### FIELD OF THE DISCLOSURE

The present invention generally relates to electronic data processing systems for implementing desired asset allocation using network flow.

### BACKGROUND OF THE INVENTION

While the concept of asset location is generally understood, the service is rarely offered by advisors to clients and is very limited in practice because the interrelatedness of accounts and the underlying calculations to determine asset allocation creates a nearly infinite number of possibilities. The reason the service is rarely offered is that, without a framework, most advisors cannot determine the best mix of assets. Additionally, the process of asset allocation to-date is manual and, thus, incapable of analyzing all possibilities available to a portfolio.

More specifically, the complexity of determining how to develop the optimal asset mix increases geometrically as you add asset classes and accounts. There are also a variety of other factors that can increase the difficulty of this determination. One of the primary factors is retaining required holdings in certain accounts. For example, if an individual needs to make a down payment on a house before the age of 59.5, the individual will want to pull that money from a Non-Qualified account to avoid penalties that apply to withdrawing money from a Qualified account before the age of 59.5. If the investments for the house are in a 20/80 stocks/bonds profile, the assets should be held in the Non-Qualified account. Likewise, a child's 529 account will often have a required allocation based upon when the funds will be needed to pay for college.

Determining what a target allocation of each account should be, according to when its assets will be needed, is an incredibly time-consuming process for an advisor and, as mentioned above, is limited in effectiveness because of the nearly infinite number of available options to each client's portfolio. In addition to this problem, even if a target allocation is determined, decisions then need to be made about which fund trades should be executed. This brings additional sets of considerations, such as: how closely the actual allocation of the account has to be to the desired allocation of the account, tax consequences of selling funds, and rules against selling, then re-buying the same fund within 30 days (a “wash sale”).

Therefore, a computer-implemented system is needed that enables advisors to take a client's desires and constraints and accomplish allocation-driven, tax minimizing, and rule abiding trading efficiently and with precision.

### BRIEF SUMMARY OF THE INVENTION

Generally, the disclosed system includes a novel computer-implemented system for managing, tracking, and communicating investment management activities, specifically, determining how to optimally arrange the assets in any number of potentially disparate accounts (e.g. IRA, 401(k), Roth IRA, annuity) so that they work together to construct the global asset allocation model recommended by a financial advisor. This process is accomplished by evaluating the possible trades available across multiple accounts using a min-cost, max-flow network flow algorithm and by taking into account preferences such as asset location, tax consequences, and more. The ability to assign preferences to any particular asset class in any available account greatly increases the speed with which an advisor can determine the optimal portfolio and implementation process.

The system can, through secure data connections, manage and store individual investment account information at the asset allocation level and connect with separate trading applications to execute the desired allocations. This separation of functions allows for automation of asset allocation with appropriate shields from trading activities, which are separately managed. Further, the system allows for more efficient data management and storage as related to complex financial transaction and performance information.

The system described herein is implemented in computer hardware described later in this document. Software is employed to manage user interface, the movement of data from user to database and reverse. Further, software is employed to connect and allow for information to move between the investment asset allocation system and software and the trading system and software.

### BRIEF DESCRIPTION OF THE DRAWINGS

FIG. 1 is a flowchart illustrating an example use of the trading process of the present invention.

FIG. 2 is a flowchart illustrating the process that occurs to input data, calculate a trade, and export data.

FIG. 3 is an exemplary illustration of setting the current holdings of a portfolio, according to one embodiment of the present invention.

FIG. 4 is an exemplary illustration of an overall asset allocation change, according to one embodiment of the present invention.

FIG. 5A is an exemplary illustration of setting preferences for a single account, according to one embodiment of the present invention.

FIG. 5B is an exemplary illustration of setting preferences for a single account, according to one embodiment of the present invention.

FIG. 6 is an exemplary illustration of trades to be executed, according to one embodiment of the present invention.

FIG. 7 illustrates a flow network used in one embodiment of the present invention.

FIG. 8 illustrates a flow network used in one embodiment of the present invention.

FIG. 9 illustrates a flow network used in one embodiment of the present invention.

FIG. 10 is a schematic block diagram of an example computing system that may be used in accordance with one embodiment of the present invention.

### DETAILED DESCRIPTION

Various user interfaces and embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims. It is understood that various omissions and substitutions of equivalents are contemplated as circumstances may suggest or render expedient, but these are intended to cover application or embodiments without departing from the spirit or scope of the claims attached hereto. Also, it is to be understood that the phraseology and terminology used herein are for the purpose of description and should not be regarded as limiting.

### DEFINITIONS

The following are a list of terms and their descriptions. They are meant to provide additional information regarding the present invention, but do not delimit the full scope of the invention.

Profile: A profile is a certain selection of assets that has a predetermined risk/return characteristic, such as low-risk, low return or high-risk, high return. An example used throughout this disclosure includes: Profile 1, which is 100% cash; Profile 2, which is 20% equity, 80% cash/bonds (fixed); Profile 3, which is 40% equity, 60% fixed; Profile 4, which is 60% equity, 40% fixed; Profile 5, which is 80% equity, 20% fixed; and Profile 6, which is 100% equity.

Profile allocation: How much of each profile we want in each account. For example, an account may hold 50% Profile 6 and 50% Profile 2 giving it overall 60% equities and 40% fixed assets.

Asset allocation: There are many widely-recognized asset types utilized in model portfolio theory, such as Large Cap Growth, Small Cap Value, Real Estate, Cash, etc. Asset allocation defines how much of each type of asset is contained within a certain portfolio or account.

Model schema: A model schema defines how profiles get converted into asset allocations. For example, Profile 6 could be represented by a diversified asset allocation including Large Cap Growth, Large Cap Value, Small Caps, etc. Alternatively, it could be represented by a less diversified set of assets, such as a simple S&P 500 ETF. Model schema can be defined by advisors.

Overall profile allocation: The profile allocation for the client's full portfolio, which may be contained within several different accounts.

Overall asset allocation: The asset allocation for the client's full portfolio, which may be contained within several different accounts.

Account: May be referred to as, for example, His IRA, Her IRA, Roth.

Account profile allocation: The profile allocation for one specific account.

Account asset allocation: The asset allocation for one specific account.

User: The user of the disclosed system, usually a financial advisor (sometimes referred to as “advisor” below).

Client: Individual(s) who owns the portfolio. Often, but not always, a couple.

Referred to as “client” or “owner” below.

### DESCRIPTION

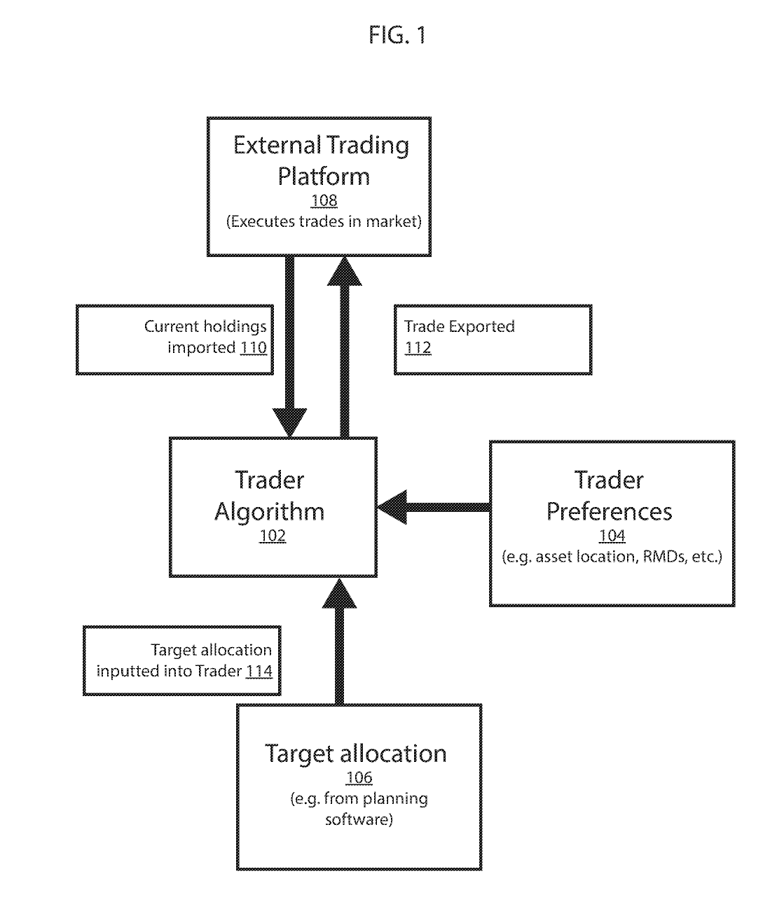

FIG. 1 is a flowchart illustrating the overall method of use of the trading algorithm disclosed herein according to one embodiment of the invention. A user can input an individual owner's beginning profile or asset allocation, a target profile or asset allocation 106, and various preferences 104 into the system. Beginning profile or asset allocation is set by an owner's current holdings, which are imported 110 into the disclosed system's algorithm 102. Target profile or asset allocation 106 can be defined in a number of ways and is inputted 114 into the disclosed system's algorithm 102. The system then creates a trade, which is a set of asset or fund buy/sells that will change the current allocation to more closely match the intended target profile or asset allocation 106. A trade is exported 112 by the system to an external trading platform 108 in the market.

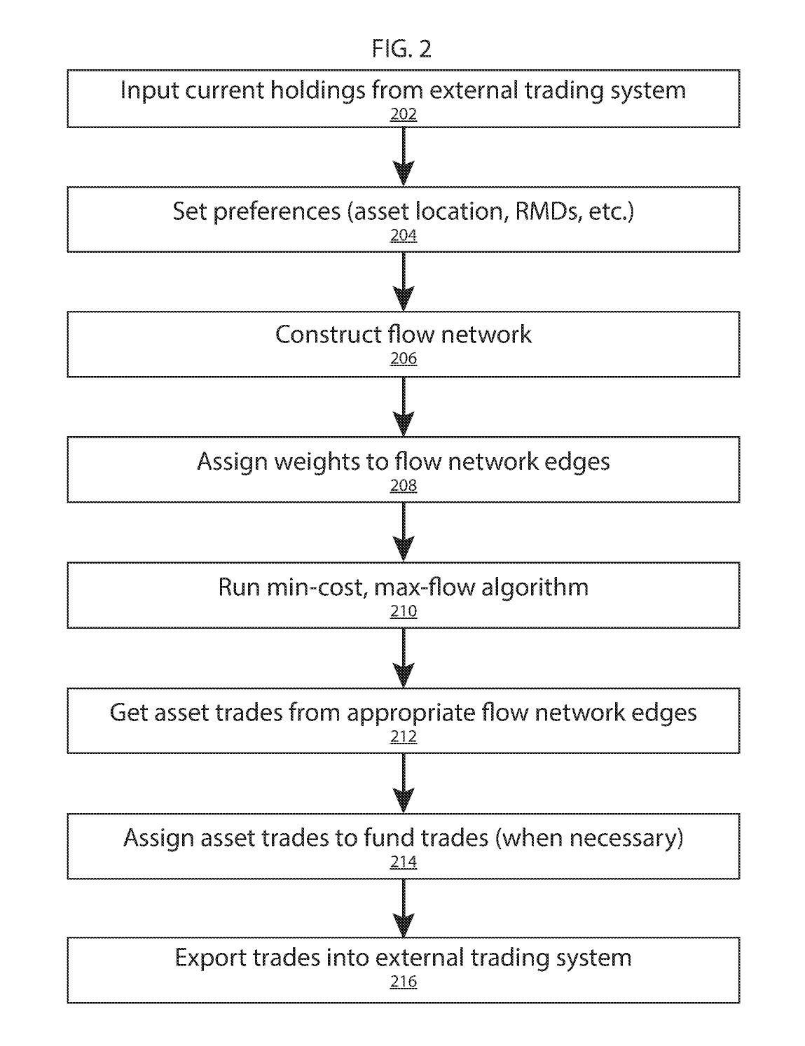

After having decided upon a target overall profile or asset allocation 106 for a client, a user, usually a financial advisor, will need to implement the overall profile or asset allocation within the client's accounts using the process depicted in FIG. 2. For example, a user can input an individual owner's current holdings from an external trading system 202. Then, the user can set preferences 204, such as asset location and required minimum distributions (RMDs), construct a flow network 206, assign weights to flow network edges 208, run a min-cost, max-flow algorithm 210, get asset trades from appropriate flow network edges 212, when necessary, assign asset trades to fund trades 214, and export trades into an external trading system 216. The summation of all of the client's account allocations is equal to the overall profile or asset allocation. The accounts have a current target profile or asset allocation 106 that can be inputted into the disclosed system 114.

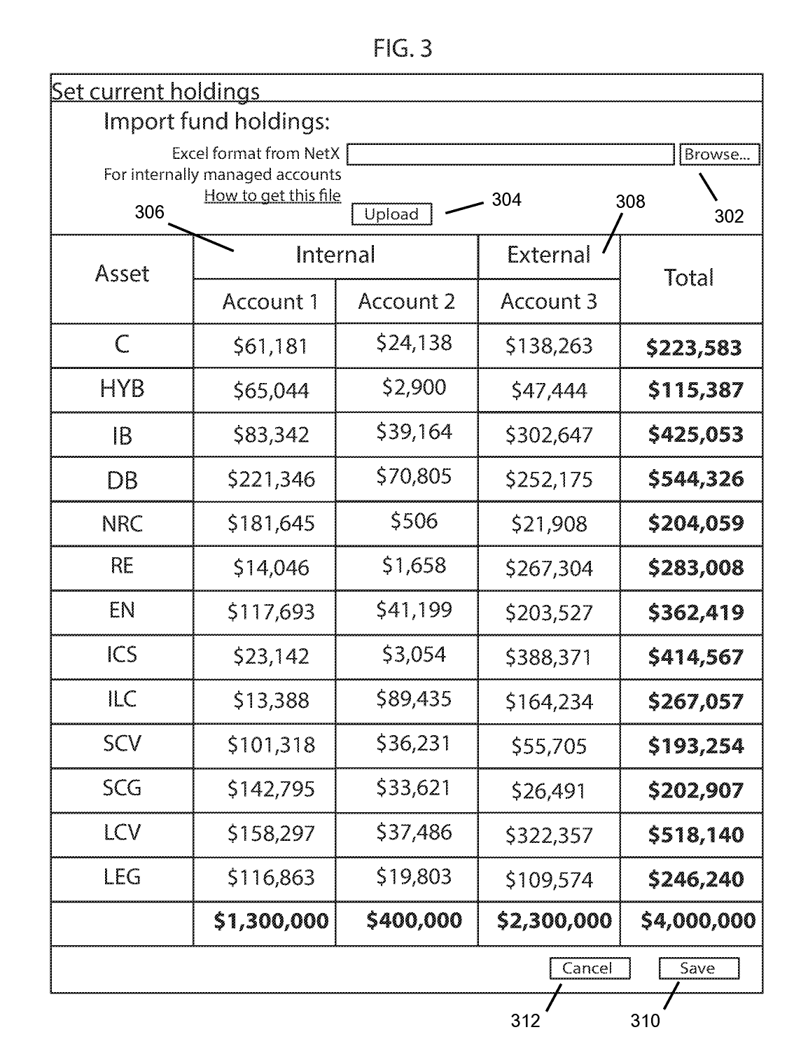

FIG. 3 illustrates one example of how to set the current holdings of the portfolio 202 with each column containing information for a single account within the portfolio 202. For example, a user can upload and import fund holdings by selecting a browse option 302 within the system and then selecting the upload button 304. Funds can be uploaded to specific internal 306 or external 308 accounts. An internal account 306 is one where a user can order-blast trades into specific funds and pull holdings automatically from a trading program used by financial advisors. An external account 308 is an account that a user cannot control or access directly, such as, but not limited to, a 401k sponsored by the client's employer. When importing holdings, a user can key in each holding, asset by asset, into whichever account the holdings belong to. Examples of assets that the system can support include, but are not limited to, cash, bonds (high yield bonds, international bonds, domestic bonds, etc.), and equities (natural resources/commodities, real estate, emerging markets, international small cap, international large cap, small cap value, small cap growth, large cap value, large cap growth, etc.). A user can view all current accounts at once and can save any recently inputted assets or accounts by selecting a save button 310. Alternatively, a user can proceed without saving any recently inputted assets or accounts by selecting a cancel button 312.

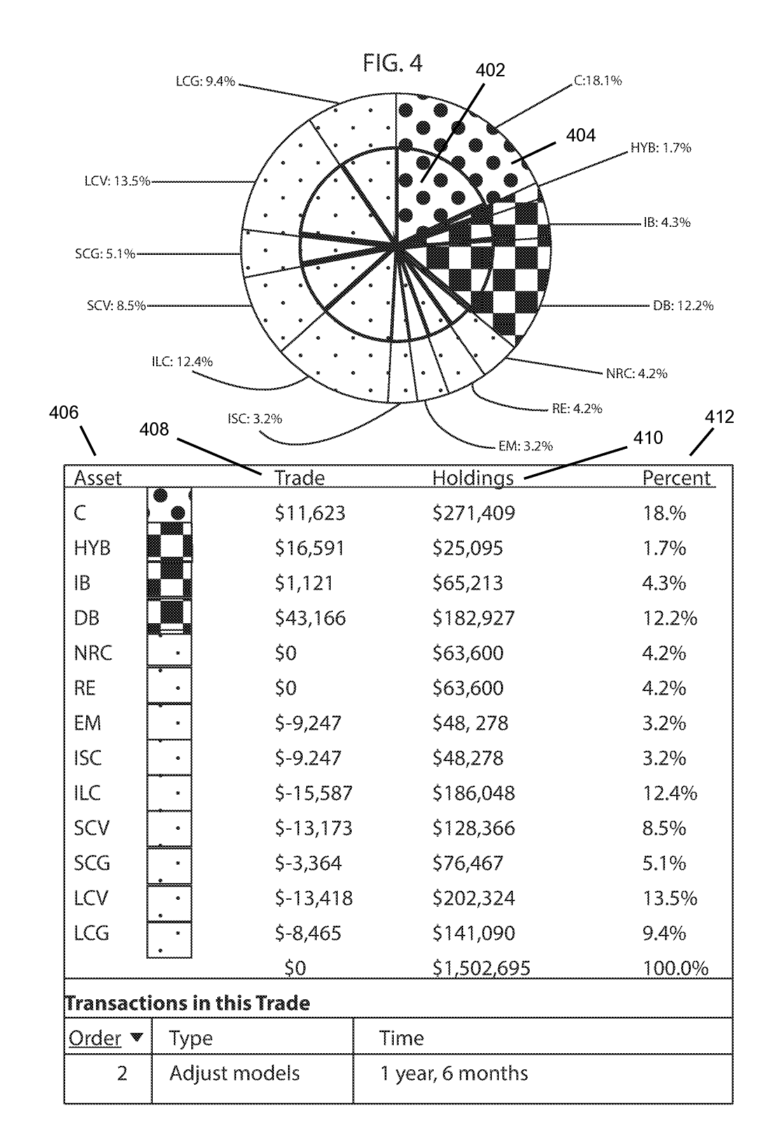

The most simplistic way of calculating the target asset allocation of the accounts as a whole is to have each account hold the same proportional allocation as the overall portfolio. So, for example, if the overall portfolio is $1 million and needs $150k in cash, an account with $100k should have $15k in cash. In one embodiment of an overall asset allocation, as illustrated in FIG. 4, the difference in asset allocation before a trade and after a trade is illustrated graphically using an inner circle 402 and outer circle 404, wherein each piece of the inner circle 402 represents the amount and percentage of that asset in the account before the trade and each piece of the outer circle 404 represents the amount and percentage of that asset in the account after the trade. In one embodiment of an overall asset allocation, also illustrated in FIG. 4, the updated value of asset allocation after a trade is illustrated by a chart. The chart can include information such as, but not limited to, asset type 406, amount to be traded of each asset 408, what the holdings will be for each asset after the trade 410, and what percentage of the portfolio the asset will comprise after the trade 412.

However, advisors will often want to favor or disfavor certain asset classes within each account. This practice is known as asset location. For example, certain asset classes may not be available in an account, or an advisor may want to more heavily weight Real Estate in a tax-deferred or Qualified account because REITs (Real Estate Investment Trusts) create more dividends, which would result in an income tax liability for the client. Locating the necessary REIT holding within a tax-deferred account reduces current taxation and increases overall levels of wealth. In general it is desirable to place tax inefficient assets (e.g. foreign bonds, REITs, commodities) into tax-sheltered accounts and place tax efficient assets (e.g. index mutual funds, exchange traded funds [EFTs], growth orientated investments) into brokerage or Non-Qualified accounts.

The process of asset location can be computationally difficult. Imagine, in the example above, that the advisor wanted to more heavily weight cash to $25k instead of $15k. The advisor would have to reduce the weighting of the other asset types in that account (because that account still needs to hold $100k), then reduce the weighting of cash in the other accounts (so we still have $150k in cash total), and then increase the weighting of the other asset classes in the other accounts so that their overall values are still correct.

For example, below are two different possible ways of allocating two asset classes across three accounts:

| | | Account A | Account B | Account C | Total Required |
|---|---|---|---|---|---|
| Option 1 | Cash | $25,000 | $50,000 | $75,000 | $150,000 |
| | Stocks | $50,000 | $75,000 | $100,000 | $225,000 |
| | | $75,000 | $125,000 | $175,000 | $375,000 |
| Option 2 | Cash | $5,000 | $100,000 | $45,000 | $150,000 |
| | Stocks | $70,000 | $25,000 | $130,000 | $225,000 |
| | | $75,000 | $125,000 | $175,000 | $375,000 |

The complexity of determining how to develop the optimal asset mix increases geometrically as you add assets classes and accounts. It also increases as you add other considerations, such as minimizing the amount that is traded within each account or taking into account certain accounts that have required holdings of a certain asset class.

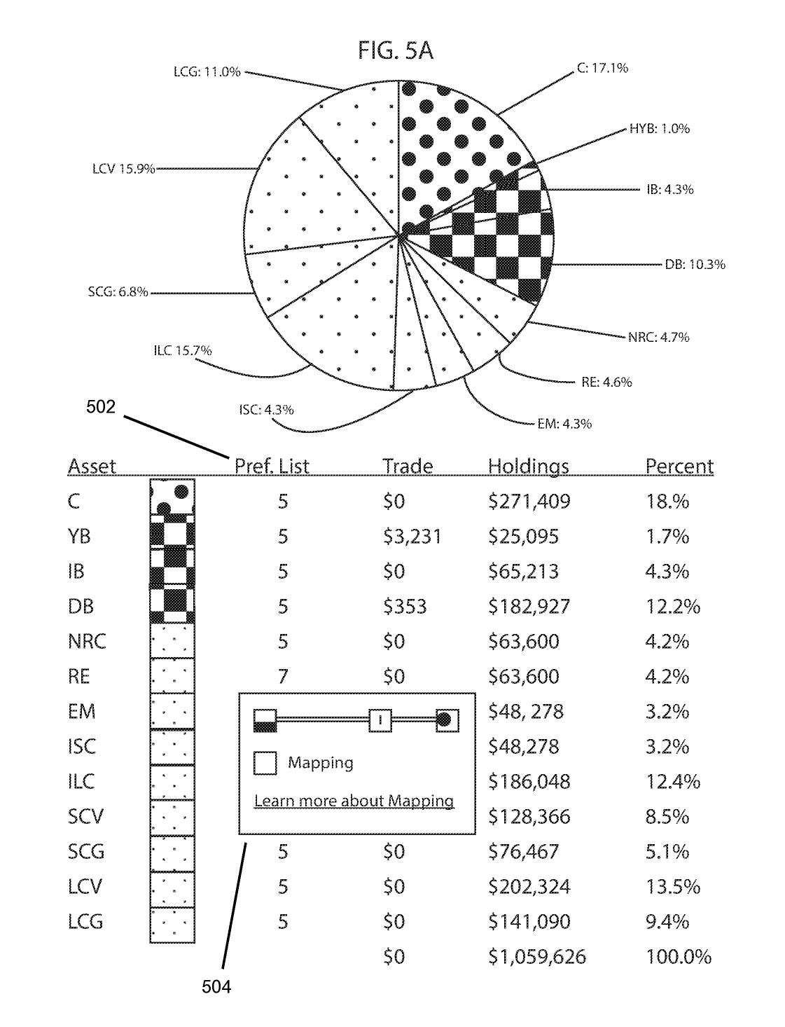

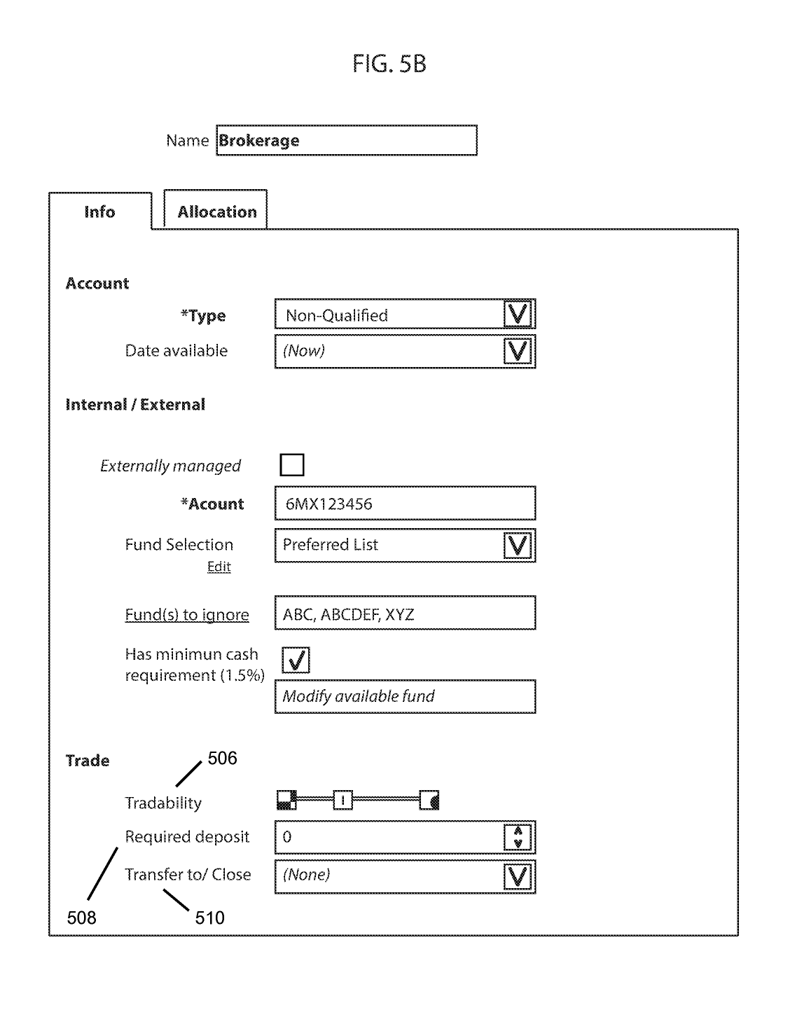

The disclosed system allows advisors to give each asset within each account a high or low “preference” 502. For example, an advisor can assign a number between zero and ten wherein a five is the default, a zero indicates that that asset is not available in that account, a one means to heavily disfavor that asset, and a ten means to heavily favor it. Using these preferences, the system can create an asset allocation for each account such that the asset location preferences are followed, accounts hold the correct total value, and the overall asset allocation is correct. FIGS. 5A and B illustrates one example of setting preferences for a single account.

In one embodiment, as illustrated in FIG. 5A, the user can use a mapping 504 option. This option allows a user to allocate the proportion of an unavailable asset class to a separate proxy asset class. For example, if international bonds are not an available asset class option in a 401k plan, the user may move the proportion allocated to international bonds to domestic bonds.

In one embodiment, as illustrated in FIG. 5B, the user can set up other account information such as, but not limited to, the account type, the date the account is available, the account number, the selected funds to make changes to, the fund or funds to ignore, whether there is a minimum cash requirement or preference, the tradability 506, an amount, if any, for a required deposit 508, and transfer to/close preferences 510.

Tradability 506 refers to the extent to which the user will allow “churn” to occur within a certain account due to tax consequences of those trades. For example, a user may want to avoid trading within a taxable 401k, but would be fine with trading within a non-taxed Roth and would therefore set tradability to be higher in the non-taxed Roth and lower in the taxable 401k.

Buying and selling assets at the same time is called “churn”. When changing the overall asset allocation in an account, often there is no net liquidation of assets. For example, $10,000 of Domestic Bonds may need to be sold so that $10,000 of Large Cap Growth can be bought. Non-Qualified accounts are taxed when funds within them are liquidated. Therefore, in this situation, taxes might need to be paid on the Domestic Bonds, but there would be no net liquidation to cover these taxes. Therefore, the disclosed system will attempt to not churn within Non-Qualified accounts to avoid unnecessary tax consequences for the client. It will instead try to make all churn trades within a tax-deferred or Qualified account.

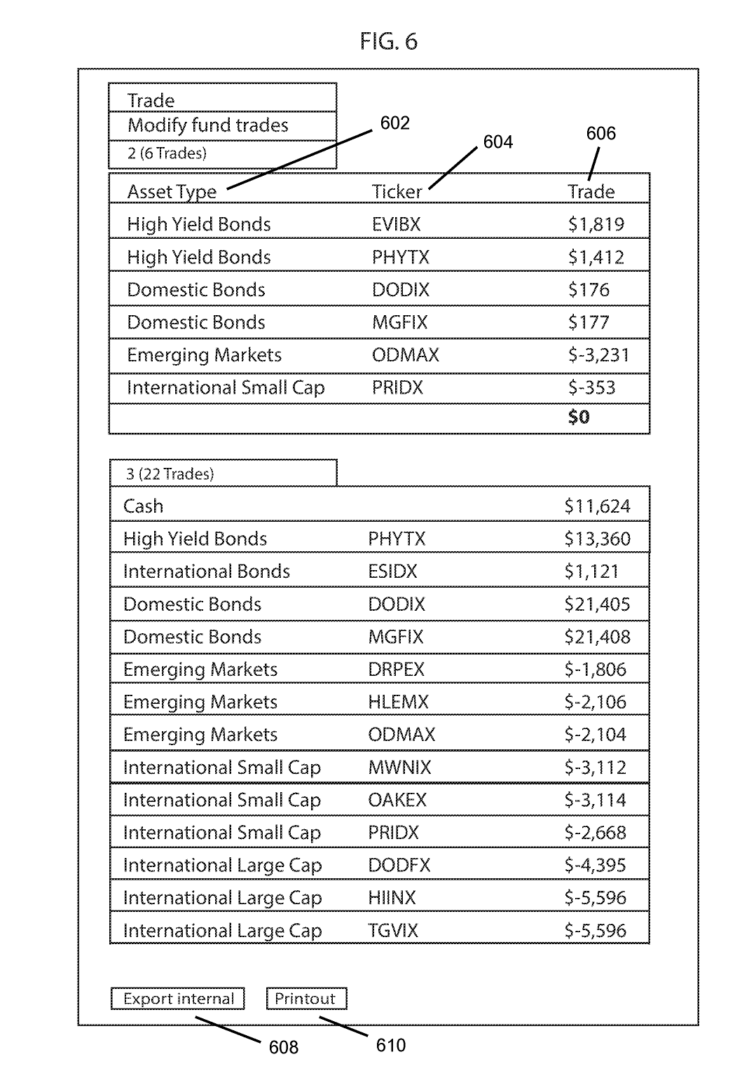

The required deposit 508 function permits money to be added or removed from an account. For example, if there is a Required Minimum Distribution (RMD) of $10,000, the user can input $10,000 in the required deposit section. Accounts often have an RMD when someone reaches a certain age, which indicates that a certain amount of money must be pulled out of an account. In one embodiment, the disclosed system will always execute an RMD before trying to satisfy other constraints. FIG. 6 illustrates an example of a set of trades to be executed for two separate accounts. Each trade displays the asset type 602 to be traded, the ticker 604 number, and the amount of the trade 606. In one embodiment of the disclosed system, sets of trades can be exported into a spreadsheet form by clicking an export internal 608 button or they can be printed out by click a printout 610 button.

The transfer to/close 510 selection refers to an action to take on the overall account. “Transfer to” is used when rolling one account over into another. “Close” is used when closing an account.

The disclosed system will follow all of the above rules, attempting to create the “best” trade across all of the accounts, taking into consideration information such as, but not limited to, asset location preferences, RMDs, and the tax status of the account.

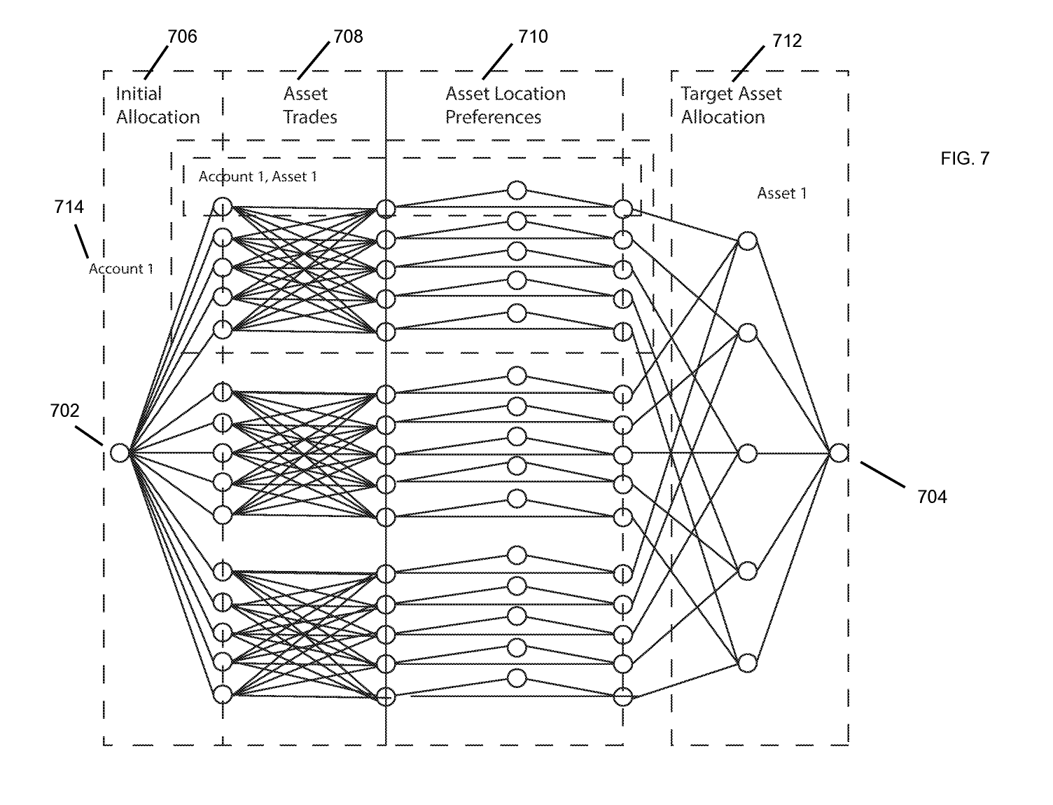

Generally, the disclosed system formulates the above problems as a min-cost, max-flow network flow problem in a database. More specifically, instead of water flowing through pipes, money flows into different asset types in different accounts. As illustrated in FIGS. 7-9, money starts at the leftmost node, which represents the “source,” and it flows through a series of allocations and trades, which are determined by profile or asset location preferences and target allocation, to its final “sink” destination at the rightmost node. Generally, nodes represent points within a database.

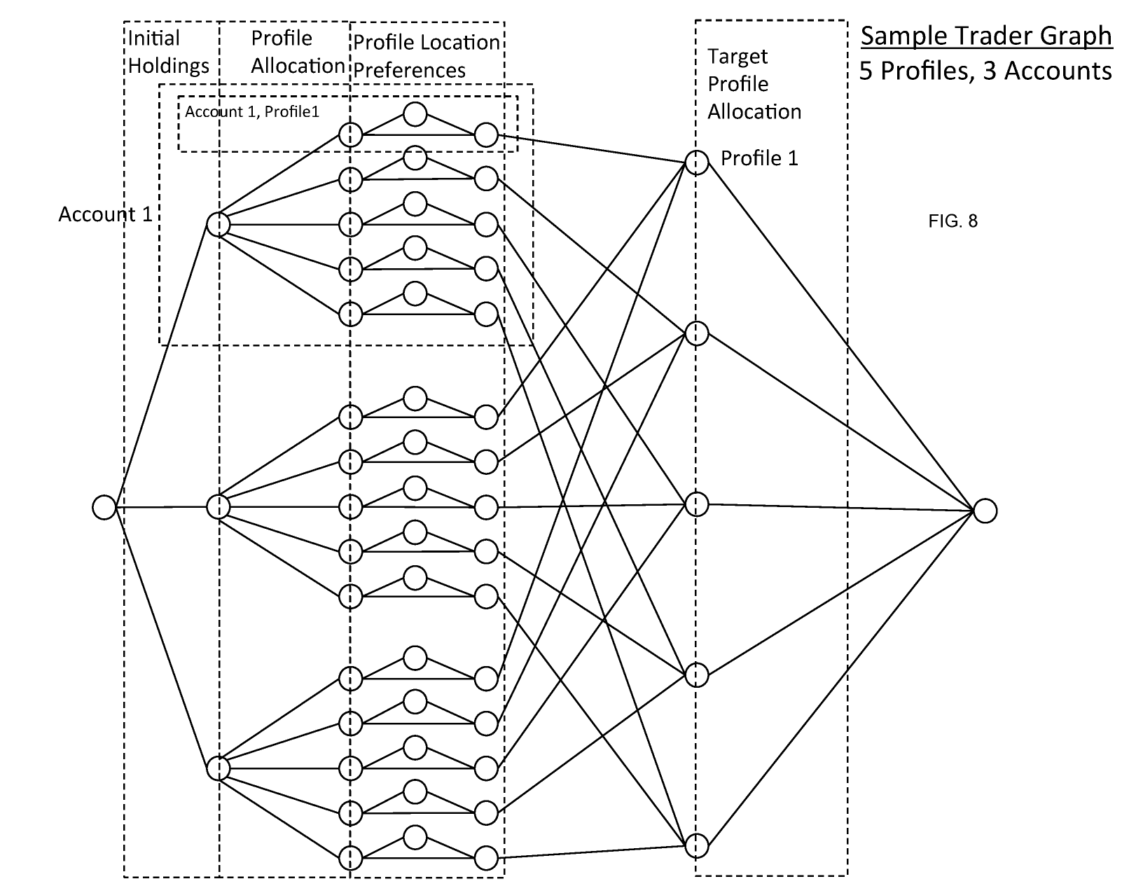

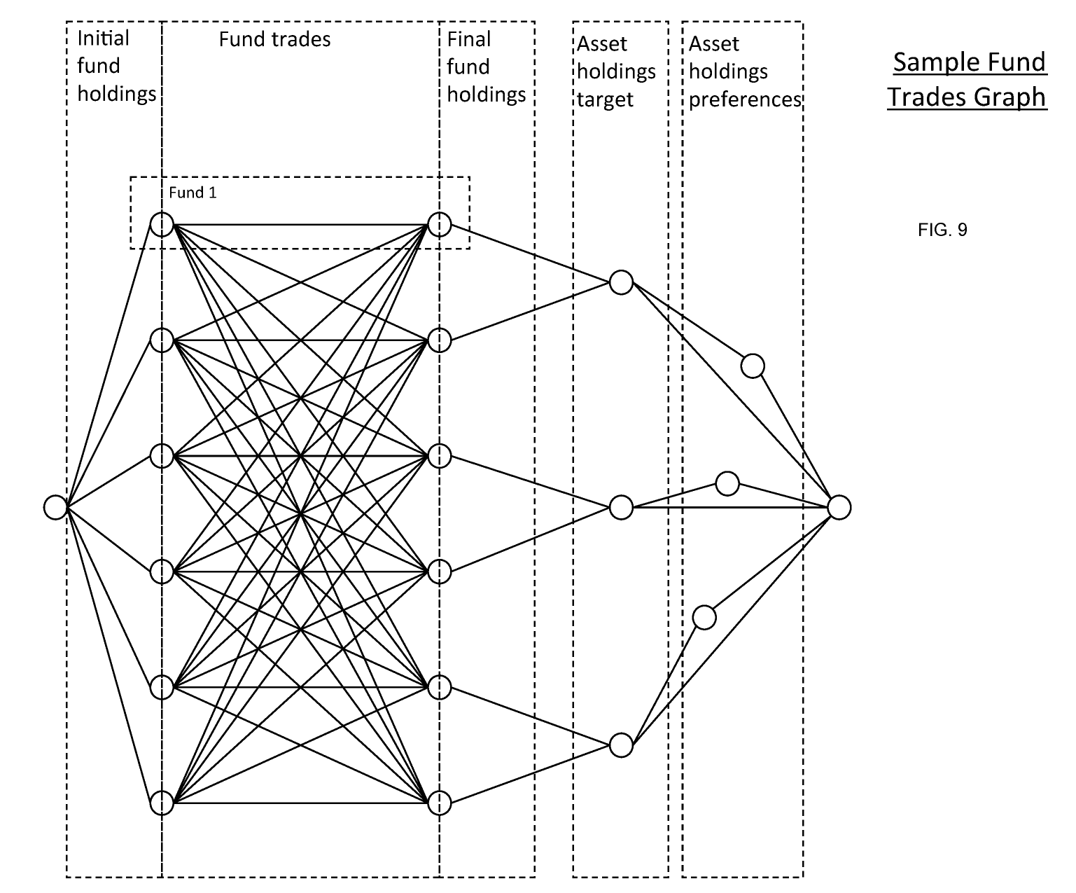

As briefly mentioned above, the disclosed system can implement desired allocations based on account profiles or assets. FIG. 7 illustrates one embodiment wherein the system focuses on asset allocation being spread out across accounts. FIG. 8 illustrates a second embodiment wherein the system focuses on profile allocation, instead of asset allocation, being spread out across accounts. FIG. 9 illustrates how the disclosed system determines the desired fund trades to accomplish desired asset holdings, as calculated by the system using the flow networks illustrated in FIG. 7 and FIG. 8.

More specifically, FIG. 7 illustrates an example where a client has five asset classes and three accounts, although other graphs can have fewer or more asset classes and any number of accounts. The top set of nodes represents Account 1 714. Each of the five nodes within Account 1 714 represents one asset within Account 1 714, as illustrated by the smallest box surrounding the topmost row of nodes in FIG. 7. Each row of nodes in the graph, thereafter, represents a separate account. In the top group, all five assets belong to Account 1 714. In the middle and bottom groups, the five assets in each belong to a second and third account, respectively.

When the disclosed system is implemented for asset-specific allocations, money starts at the leftmost node 702, which represents the “source,” and it flows through a series of allocations 706 and trades 708, which are determined by asset location preferences 710 and target asset allocation 712, to its final “sink” destination at the rightmost node 704.

As illustrated in the network flow graphs in FIGS. 8 and 9, the disclosed system can use profiles to take a desired asset allocation and convert a portfolio owner's initial asset allocation into the desired asset allocation.

As described above, a profile is a certain selection of assets that has a predetermined risk/return characteristic. For example, a cash-heavy profile will tend to have low risk in the short term, but also low return in the long term. An equity-heavy profile will have higher risk in the short term, but higher return in the long term. Profiles are generally chosen based on upon when those assets need to be spent. For example, money that needs to be spent in one year will be allocated in a cash-heavy profile, where as money not needed for at least 30 years will be in an equity-heavy profile. In some embodiments, there are six profiles, wherein Profile 1 is a cash-heavy profile, holding 0% equities; Profile 2 holds 20% equities; Profile 3 holds 40% equities, Profile 5 holds 60% equities, and Profile 6 is an equity-heavy profile holding 100% equities. The rest of the holdings of each Profile, except Profile 6, which is 100% equities, are cash or bonds.

In some embodiments, the system can use profile allocation to create a portfolio with various percentages of the above-described Profiles (account profile allocation is the profile allocation for one specific account). For example, a portfolio having three accounts of similar values may have a profile allocation of 40% Profile 6, 30% Profile 5, and 30% Profile 2, and Account 1 may have an account profile allocation of 100% Profile 6, thereby accounting for 33% of the 40% Profile 6 allocation in the portfolio. The disclosed system can split out these Profiles between different available accounts and convert the assets within the accounts into actual fund holdings. In some embodiments, the system can take into account when certain profiles need to be held in specific accounts. For example, if a portfolio owner plans to spend money before the age of 59.5, the owner would want to spend that money from a Non-Qualified account in order to avoid penalties. Therefore, the portfolio owner may be required to hold short-term money (e.g., Profile 2) in a Non-Qualified account.

In some embodiments, a model describes how a specific profile is represented as an asset allocation. The model used may depend on a variety of factors, including the tax status of an account and the size of an account. For example, a Non-Qualified account may not want to hold REITs because they product large amounts of taxable income, while a Qualified account could hold these without tax consequences. Furthermore, to reduce trading costs of assets that will be traded, those assets may be held in a smaller account (e.g., $1,000), while the remaining assets may be held in a larger account (e.g., $1,000,000).

Once a profile allocation is determined, the profile can be run through a model schema within that account, which the advisor can use to express how the profiles should be represented in terms of assets, so that the account asset allocation can be determined. This asset allocation can represent a desired asset allocation for the specific account.

FIG. 8 illustrates an example trader network graph for a Portfolio having nodes and edges connecting the categories of “Initial Holdings,” “Profile Allocation,” “Profile Location Preferences,” and “Target Profile Allocation.” As illustrated in FIG. 8, one portfolio owner has five profiles that are applied to each of three accounts. For example, Account 1 contains Profile 1, Profile 2, Profile 3, Profile 4, and Profile 5; Account 2 contains Profile 1, Profile 2, Profile 3, Profile 4, and Profile 5; and Account 3 contains Profile 1, Profile 2, Profile 3, Profile 4, and Profile 5. In some embodiments, the trader network graph can incorporate six profiles and a variable number of accounts.

The capacity of the edges within the “Initial Holdings” category, in one embodiment, is set to the total initial holdings of each account. As illustrated in FIG. 8, the topmost edge in the “Initial Holdings” category represents the Account 1 edge leading to the Profile edges within Account 1.

Within the “Profile Allocation” category, the edges have no capacity, but their flow after running an algorithm will contain the profile allocation for each account. These edges connect into the “Initial Holdings” category for each account, ensuring that the overall profile allocation will add up to the overall account holdings.

Within the “Profile Location Preferences” category, the edges are used to force certain accounts to hold more or less of a predetermined profile. For example, if $10,000 of Profile 2 is required to be in a Non-Qualified account, the system can add an edge to the “Profile Location Preferences” category with a capacity of 10,000 and a large negative cost. This setup can force the system to put 10,000 of Profile 2 into the Non-Qualified account, possibly by pulling it out of other accounts and, if necessary, pushing the other profiles that are in the Non-Qualified account into other accounts. Less stringent requirements can also be put on specific accounts. For example, if Profile 6 is favored in a Roth account, the system will put a lower cost on the Profile 6 edge in the Roth account. Further, if Profile 1 is disfavored in a Roth account, the system will put a higher cost on the Profile 1 edge for the Roth account, thus making it easier for Profile 6 assets to move into the Roth account and more difficult for Profile 1 assets to move into the Roth account.

Within the “Target Profile Allocation” category, the nodes associate with a specific profile and connect, via edges, to their profile's nodes within each of the accounts. As illustrated in FIG. 8, the “Target Profile Allocation” Profile 1 node connects to Profile 1 nodes within each of the three accounts. This setup ensures that the total holdings across all of the accounts of each profile equal the total amount desired. The capacities of these edges are set to the expected holdings of each profile across the entire portfolio (i.e., in all accounts).

FIG. 9 illustrates an example fund trades network graph for a Portfolio having nodes and edges connecting the categories of “Initial fund holdings,” “Fund trades,” “Final fund holdings,” “Asset holdings target,” and “Asset holdings preferences.” As illustrated in FIG. 9, each of the funds in a portfolio can trade with other funds. In some embodiments, the fund trades network graph can incorporate any number of assets and funds.

The capacity of the edges within the “Initial fund holdings” category, in one embodiment, is set to the initial holdings of each fund. As illustrated in FIG. 9, the topmost edge in the “Initial fund holdings” category represents the Fund 1 edge leading to the Fund 1 nodes of Fund 1.

Within the “Fund trades” category, the edges affect the fund trades that can happen. For example, if the trading done within a fund needs to be limited, the system can apply a high cost to the edges connecting that fund to any other, which will push the system to keep holdings within the fund that the holdings originated in. If a fund cannot be purchased, no edges will connect it to the “Final fund holdings” node. If a first fund cannot be sold, no edges will connect the first fund's “Initial holdings” node to any other fund's “Final fund holdings” node.

Within the “Final fund holdings” category, the flow through the edges represents the final holdings of each fund after trading.

Within the “Asset holdings target” category, the nodes are connected to their constituent funds. For example, IBM and Microsoft may both be connected to a “Large Cap Value” asset. This ensures that each asset holds what it should between the different funds that represent it.

Within the “Asset holdings preferences” category, the system sets the capacity of the corresponding edges to ensure that the account matches its desired account asset allocation. However, “overflow” edges can be created that allow the allocation to be different than the desired allocation based upon preferences such as not being able to sell a certain fund based upon tax consequences. The costs on these overflow edges indicate how strictly the system should match the overall allocation. Therefore, a higher cost encourages the allocation to match more closely to the desired allocation, and a lower cost allows the final allocation to stray further from its desired allocation.

The max-flow part of the algorithm ensures that the entire portfolio can be allocated and it comes up with one possible allocation of the assets or profiles across the different accounts. Certain setups are impossible to satisfy, such as one where every account has Domestic Bonds set as preference zero, but the overall portfolio requires some Domestic Bonds. The max flow part of the algorithm can detect this.

The min-cost part of the algorithm is used to find the optimal way to allocate the assets or profiles. A higher preference number on an account-asset reduces the cost of its pipes, encouraging the system to allocate more toward that account-asset. Similarly, RMDs are represented by edges with an extremely negative weight, which forces the system to satisfy the RMD above all else.

The ability to assign preferences to any particular asset class in any available account greatly increases the speed with which an advisor can determine the optimal portfolio from an asset location standpoint. With the algorithm and interface provided, advisors can determine the optimal location of each asset class while honoring the overall asset allocation between any number of accounts the client may own in seconds.

The preferences and results of each trade are stored in the system for the full life of the portfolio so that they can be referred back to in order to track the history of the portfolio.

The disclosed system interacts with the external trading system by importing and exporting spreadsheets (CSV files). With this system, advisors are able to review all trades before they are actually implemented, which provides an additional security and quality benefit for the client.

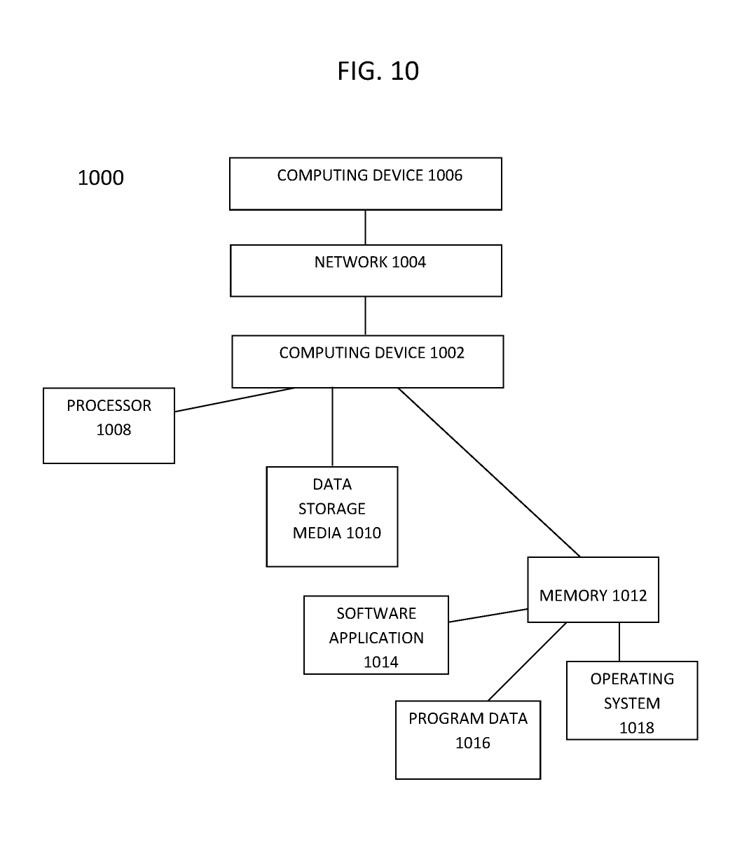

The disclosed invention involves technology that uses a computing system. FIG. 10 is a schematic block diagram of an example computing system 1000. The invention includes at least one computing device 1002. In some embodiments the computing system further includes a communication network 1004 and one or more additional computing devices 1006 (such as a server).

Computing device 1002 can be, for example, located in a place of business or can be a computing device located in a user's home or office. In some embodiments, computing device 1002 is a mobile device. Computing device 1002 can be a stand-alone computing device or a networked computing device that communicates with one or more other computing devices 1006 across a network 1004. The additional computing device(s) 1006 can be, for example, located remotely from the first computing device 1002, but configured for data communication with the first computing device 1002 across a network 1004.

In some examples, the computing devices 1002 and 1006 include at least one processor or processing unit 1008 and system memory 1012. The processor 1008 is a device configured to process a set of instructions. In some embodiments, system memory 1012 may be a component of processor 1008; in other embodiments system memory is separate from the processor. Depending on the exact configuration and type of computing device, the system memory 1012 may be volatile (such as RAM), non-volatile (such as ROM, flash memory, etc.) or some combination of the two. System memory 1012 typically includes an operating system 1018 suitable for controlling the operation of the computing device, such as the Linux operating system. The system memory 1012 may also include one or more software applications 1014 and may include program data 1016.

The computing device may have additional features or functionality. For example, the device may also include additional data storage devices 1010 (removable and/or non-removable) such as, for example, magnetic disks, optical disks, or tape. Computer storage media 1010 may include volatile and nonvolatile, removable and non-removable media implemented in any method or technology for storage of information, such as computer readable instructions, data structures, program modules, or other data. System memory, removable storage, and non-removable storage are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing device. An example of computer storage media is non-transitory media.

In some examples, one or more of the computing devices 1002, 1006 can be located in a financial planner's place of business. In other examples, the computing device can be a personal computing device that is networked to allow the user to access the present invention at a remote location, such as in a user's home, office or other location. In some embodiments, the computing device 1002 is a smart phone, tablet, laptop computer, personal digital assistant, or other mobile computing device. In some embodiments the invention is stored as data instructions for a smart phone application. A network 1004 facilitates communication between the computing device 1002 and one or more servers, such as an additional computing device 1006, that host the system. The network 1004 may be a wide variety of different types of electronic communication networks. For example, the network may be a wide-area network, such as the Internet, a local-area network, a metropolitan-area network, or another type of electronic communication network. The network may include wired and/or wireless data links. A variety of communications protocols may be used in the network including, but not limited to, Wi-Fi, Ethernet, Transport Control Protocol (TCP), Internet Protocol (IP), Hypertext Transfer Protocol (HTTP), SOAP, remote procedure call protocols, and/or other types of communications protocols.

In some examples, the additional computing device 1006 is a Web server. In this example, the first computing device 1002 includes a Web browser that communicates with the Web server to request and retrieve data. The data is then displayed to the user, such as by using a Web browser software application. In some embodiments, the various operations, methods, and rules disclosed herein are implemented by instructions stored in memory. When the instructions are executed by the processor of one or more of the computing devices 1002 and 1006, the instructions cause the processor to perform one or more of the operations or methods disclosed herein. Examples of operations include communication between or among users; task list and order set management; dashboard functions; the storage of account information for multiple users; and other operations.

The various embodiments described above are provided by way of illustration only and should not be construed to limit the claims attached hereto. Those skilled in the art will readily recognize various modifications and changes that may be made without following the example embodiments and applications illustrated and described herein and without departing from the true spirit and scope of the following claims.

1. A computer-implemented method for implementing desired asset allocation, the method comprising:
inputting current assets from an external trading system into an account;
storing the inputted current assets in the account;
setting a preference for each inputted asset, wherein each asset is given a value that determines its importance relative to other assets;
setting a target allocation for the current assets;
constructing a flow network;
assigning weights to the flow network's edges;
running a min-cost, max-flow algorithm, wherein the inputted assets are allocated to the target allocation;
receiving information from the min-cost, max-flow algorithm about at least one asset trade that will move the assets closer to the target allocation;
using the collected information to recommend at least one asset trade; and
exporting the at least one recommended asset trade to an external trading platform.

2. The method of claim 1, wherein the account is an internal account.

3. The method of claim 1, wherein the account is an external account.

4. The method of claim 1, wherein the assets are cash.

5. The method of claim 1, wherein the assets are bonds.

6. The method of claim 1, wherein the assets are equities.

7. The method of claim 1, further comprising allocating each asset a proportion.

8. The method of claim 7, further comprising weighing a first asset heavier by moving the proportion allocated from a second asset to the first asset.

9. The method of claim 1, further comprising displaying inputted assets and post-trade assets, wherein an inner circle represents all inputted assets and an outer circle represents all assets after a recommended trade has been exported.

10. The method of claim 1, further comprising collecting information about the account's required minimum distributions.

11. A computer-implemented system for implementing desired asset allocation comprising:
at least one computer memory storing instructions for managing and analyzing asset data; and
at least one computer processor programmed for accessing the stored instructions and performing steps including:
inputting current assets from an external trading system into an account;
storing the inputted current assets in the account;
setting a preference for each inputted asset, wherein each asset is given a value that determines whether it is more or less likely to be traded;
setting a target allocation for the current assets;
constructing a flow network;
assigning weights to the flow network's edges;
running a min-cost, max-flow algorithm, wherein the inputted assets are allocated to the target allocation;
receiving information from the min-cost, max-flow algorithm about at least one asset trade that will move the assets closer to the target allocation;
using the collected information to recommend at least one asset trade; and
exporting the at least one recommended asset trade to an external trading platform.

12. The method of claim 11, wherein the account is an internal account.

13. The method of claim 11, wherein the account is an external account.

14. The method of claim 1, wherein the assets are cash.

15. The method of claim 11, wherein the assets are bonds.

16. The method of claim 11, wherein the assets are equities.

17. The method of claim 11, further comprising allocating each asset a proportion.

18. The method of claim 17, further comprising weighing a first asset heavier by moving the proportion allocated from a second asset to the first asset.

19. The method of claim 11, further comprising displaying inputted assets and post-trade assets, wherein an inner circle represents all inputted assets and an outer circle represents all assets after a recommended trade has been exported.

20. The method of claim 11, further comprising collecting information about the account's required minimum distributions.
